(19) United States
(12) Patent Application Publication
(10) Pub. No.: US 2002/0003987 A1
(43) Pub. Date: Jan. 10, 2002

(54) MARKING ELEMENT

(76) Inventor: GERHARD SCHULER, WATTENS (AT)

Correspondence Address: MENDEROTH, LIND & PONACK, 2033 K STREET N. W. SUITE 800, WASHINGTON, DC, 20006, US

(21) Appl. No.: 09/270,011

(22) Filed: Mar. 16, 1999

(30) Foreign Application Priority Data
Jul. 21, 1998 (AT) GM-498/98

(51) Int. Cl. G08B 1/00

(52) U.S. Cl. 404/14

(57) ABSTRACT

An approximately cuboidal or frustopyramidal, partially hollow marking element provided with a flat bottom plate, with a main body which is stiffened by ribs and which is connected at two mutually opposite sides to preferably reflecting bars, wherein the marking element only comprises the bars (1) and the main body (2) which is integral with the bottom plate (3) and in the interior of which a plurality of ribs (5) extend normal to the bars (1) but on the other hand at most one rib (4) extends parallel to the bars (1).

The invention relates to an approximately cuboidal or frustopyramidal, partially hollow marking element provided with a flat bottom plate, with a main body which is stiffened by ribs and which is connected at two mutually opposite sides to preferably reflecting bars.

A marking element of that kind is known from U.S. Pat. No. 4,340,419. By virtue of the bottom plate provided in that arrangement, it is relatively simple to stick it to the carriageway while the ribs on the main body afford the main body the necessary strength for it to be run over by vehicles. A disadvantage with the known arrangement however is that both the bottom plate and the two non-reflecting side walls form separate parts which each have to be connected to the main body.

The applicants on the other hand have already marketed a marking element which only comprises a main body injection-molded from plastic material and two reflecting bars or strips connected thereto. The stiffening ribs form a close grid, which means that the molding can only be removed from the mold in a downward direction so that the marking element has a plurality of downwardly open cavities and only the free ends of the ribs can be glued to the carriageway.

The object of the present invention is so to design a marking element of the kind defined in the opening part of this specification. while maintaining its static properties, that it can be easily manufactured. That object is attained in that the marking element only comprises the bars and the main body which is integral with the bottom plate and in the interior of which a plurality of ribs extend normal to the bars but on the other hand at most one rib extends parallel to the bars.

The main body according to the invention forms a tube whose open ends are closable by the reflecting bars. As the ribs in the interior of the tube extend in the longitudinal direction thereof, the main body can be easily removed from an injection-molding tool after production thereof in the injection-molding tool, as it is only necessary to provide a mold core which extends parallel to the tube and which finally has to be pulled out. If two such mold cores are provided, then a rib extending parallel to the reflecting bars can be arranged in the middle of the hollow body so that the ribs cross at the center of the marking element and the central region becomes particularly strong and stable.

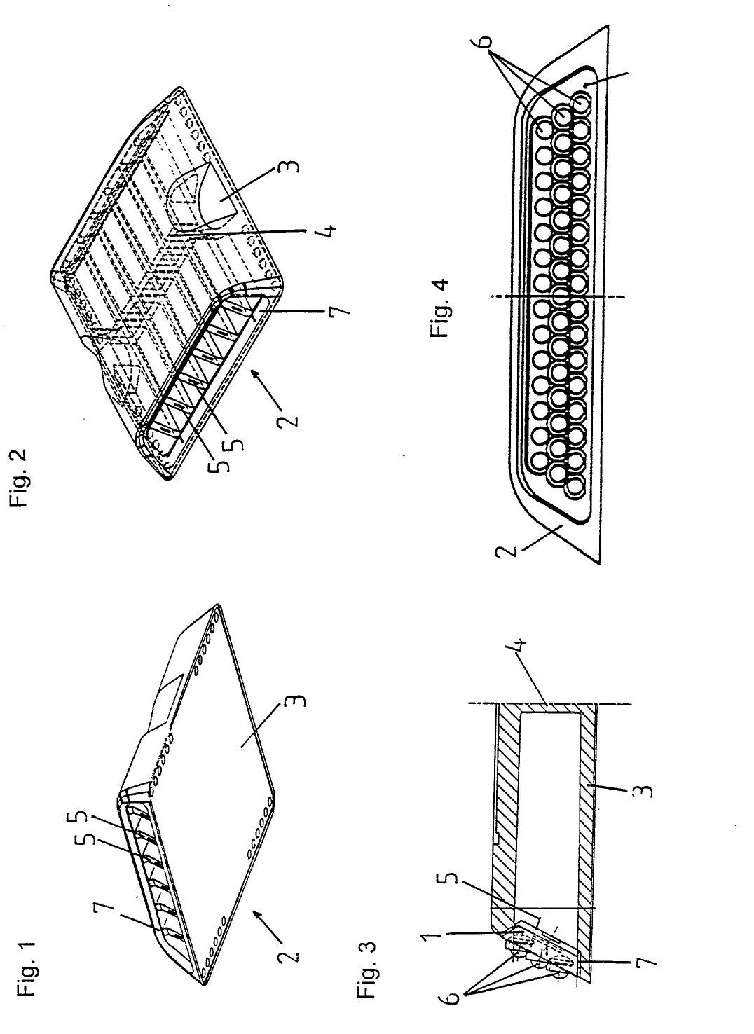

Further details of the invention are described hereinafter with reference to the drawing in which FIG. 1 is a diagrammatic view of the main body of the marking element obliquely from below, FIG. 2 is a view of the same main body viewing transparently therethrough and obliquely from above, FIG. 3 is a view in section parallel to two ribs 5 in FIGS. 1 and 2 with inserted reflecting bar, and FIG. 4 is a view onto the finished marking element, seen from the left in relation to FIG. 3.

The main body 2 for a marking element, as shown in FIG. 1. is an integrally produced molding of plastic material. It is of a symmetrical configuration relative to the longitudinal and transverse central plane and has an open edge 7 at two mutually opposite ends. Six stiffening ribs 5 extend in the longitudinal direction of the main body 2 which has a bottom plate.

By virtue of the fact that the marking element is of a symmetrical structure and the ribs 5 extend in the longitudinal direction, the mold core which, in the injection-molding procedure, fills the intermediate spaces between the ribs 5 can be easily removed. If two mold cores which can be pulled in opposite directions are used, it is possible to provide in the central region of the marking element a rib 4 which extends substantially normal to the ribs 5.

As can be seen from FIG. 3, reflecting strips or bars 1 can be fitted into the main body 2. In the illustrated case, they comprise plastic material and carry glass reflector elements 6. The bars 1 are fitted on both sides of the main body 2 in a slightly inclined position into the open ends of the main body 2 and are welded to the respective edge 7 by means of ultrasound. Viewed from the left in relation to FIG. 3, that thus gives the view shown in FIG. 4 of the finished marking element.

Instead of consisting of plastic material the marking element could be made from metal, preferably by means of aluminum die casting. One or even both reflecting bars 1 could be replaced by dummy bars.

1. An approximately cuboidal or frustopyramidal, partially hollow marking element provided with a flat bottom plate, with a main body which is stiffened by ribs and which is connected at two mutually opposite sides to preferably reflecting bars, characterized in that the marking element only comprises the bars (1) and the main body (2) which is integral with the bottom plate (3) and in the interior of which a plurality of ribs (5) extend normal to the bars (1) but on the other hand at most one rib (4) extends parallel to the bars (1).

2. A process for the production of the marking element as set forth in claim 1 characterized in that the main body (2) is produced in an injection-molding tool with two mold cores which engage between the ribs (5) and which can be pulled in opposite directions, and is then connected to the bars (1) by ultrasonic welding.
